(19) United States
(12) Patent Application Publication
(10) Pub. No.: US 2025/0343873 A1
(43) Pub. Date: Nov. 6, 2025

(54) VIDEO LAG DETECTION METHOD, VIDEO LAG DETECTION DEVICE, COMPUTER DEVICE, COMPUTER-READABLE STORAGE MEDIUM, AND COMPUTER PROGRAM PRODUCT

(71) Applicant: Glenfly Tech Co., Ltd., Shanghai (CN)

(72) Inventors: Zhanpeng JIA, Shanghai (CN); Shihua HUANG, Shanghai (CN); Wanli YU, Shanghai (CN); Zhenhua BO, Shanghai (CN)

(21) Appl. No.: 19/195,230

(22) Filed: Apr. 30, 2025

(30) Foreign Application Priority Data
May 6, 2024 (CN) 202410553626.9

(51) Int. Cl. H04N 7/01

(52) U.S. Cl. CPC H04N 7/013

(57) ABSTRACT

A video lag detection method, a video lag detection device, a computer device, a computer-readable storage medium and a computer program product are provided. The method includes: obtaining a lag parameter value corresponding to a to-be-detected video based on a video processing hardware; obtaining a frame rate of the to-be-detected video, and processing the lag parameter value based on the frame rate to obtain a relative lag parameter value; and performing lag detection on the to-be-detected video based on the relative lag parameter value. With the method, detection efficiency can be enhanced and resource occupancy can be reduced.

### CROSS-REFERENCE TO RELATED APPLICATION

This application claims priority to Chinese Patent Application No. 202410553626.9, filed with CNIPA on May 6, 2024, entitled “VIDEO LAG DETECTION METHOD, VIDEO LAG DETECTION DEVICE, COMPUTER DEVICE, COMPUTER-READABLE STORAGE MEDIUM, AND COMPUTER PROGRAM PRODUCT”, the entire contents of which are incorporated herein by reference.

### TECHNICAL FIELD

The present application relates to the technical field of video detection and, in particular, to a video lag detection method, a video lag detection device, a computer device, a computer-readable storage medium, and a computer program product.

### BACKGROUND

Video users have continuously enhanced requirements on codec performance of GPUs as the multimedia technology develops rapidly. Whether fluent playing of the videos can be enabled is one of the most important concerns of users.

For Research&Development manufacturers, determining occurrences of video lags and quickly locating reasons of the video lags are of high importance for works such as device improvements, device upgrading, and the like.

Current main technologies achieve video lag detection based on user perception level, with which video lags can be accurately identified. However, image processing sets high requirements for the computing platform, resulting in high resource occupancy and low efficiency.

### SUMMARY

In view of the above technical problem, a video lag detection method, a video lag detection device, a computer device, a computer-readable storage medium and a computer program product are provided, which may improve detection efficiency and reduce resource occupancy.

In a first aspect, the present application provides a video lag detection method, which includes:
obtaining, based on a video processing hardware, a lag parameter value corresponding to a to-be-detected video;
obtaining a frame rate of the to-be-detected video, and processing the lag parameter value based on the frame rate to obtain a relative lag parameter value; and
performing lag detection on the to-be-detected video based on the relative lag parameter value.

In an embodiment, the lag parameter value includes at least one of a decode frame rate or a video display frame rate.

In an embodiment, obtaining, based on the video processing hardware, the lag parameter value corresponding to the to-be-detected video includes:
obtaining a video decoding processing identifier corresponding to each channel of to-be-detected video;
obtaining a current time window corresponding to the video decoding processing identifier;
obtaining a number of times of video processing corresponding to each video decoding processing identifier returned by the video processing hardware within the current time window; and
obtaining the lag parameter value of each channel to-be-detected video based on the corresponding number of times of video processing and the corresponding current time window.

In an embodiment, before obtaining the current time window corresponding to the video decoding processing identifier, the video lag detection method further comprises:
receiving a setting instruction for the current time window, the setting instruction carrying a detection sensitivity;
obtaining the current time window based on an inter-frame time interval of the to-be-detected video and the detection sensitivity.

In an embodiment, performing lag detection on the to-be-detected video based on the relative lag parameter value includes:
updating a lag count in a case where the relative lag parameter value is greater than a first lag threshold;
obtaining a lag count threshold corresponding to the to-be-detected video, the lag count threshold being positively correlated with duration information of the to-be-detected video; and
determining that playing of the to-be-detected video is lagged in a case where the lag count is greater than the lag count threshold.

In an embodiment, the video lag detection method further includes:
obtaining the first lag threshold based on the frame rate of the to-be-detected video.

In an embodiment, the video lag detection method further includes:
obtaining an auxiliary lag parameter value; and
performing lag detection on the to-be-detected video based on the auxiliary lag parameter value.

In an embodiment, the video lag detection method further includes:
outputting a diagnostic state corresponding to the relative lag parameter value in a case where the relative lag parameter value is greater than the first lag threshold;
outputting a diagnostic state corresponding to the auxiliary lag parameter value in a case where the auxiliary lag parameter value is greater than a second lag threshold; and
determining a lag reason based on the diagnostic state corresponding to the relative lag parameter value and the diagnostic state corresponding to the auxiliary lag parameter value.

In an embodiment, the video lag detection method further includes:
recording a video moment corresponding to the relative lag parameter value, a decoding mode of the to-be-detected video, and a display mode of the to-be-detected video in a case where the relative lag parameter value is greater than the first lag threshold; and
performing a lag analysis based on the video moment corresponding to the relative lag parameter value, the decoding mode of the to-be-detected video, and the display mode of the to-be-detected video.

In a second aspect, the present application further provides a video lag detection device, which includes:
a lag parameter value obtaining module, configured to obtain, based on a video processing hardware, a lag parameter value corresponding to a to-be-detected video;
a relative lag parameter value obtaining module, configured to: obtain a frame rate of the to-be-detected video, and process the lag parameter value based on the frame rate to obtain a relative lag parameter value; and
a first detection module, configured to perform lag detection on the to-be-detected video based on the relative lag parameter value.

In a third aspect, the present application further provides a computer device, which includes a memory and a processor. The memory stores a computer program. The processor, when executing said computer program, implements steps of the video lag detection method of any of the foregoing embodiments.

In a fourth aspect, the present application further provides a computer-readable storage medium having a computer program stored thereon. The computer program, when executed by a processor, implements steps of the video lag detection method of any of the foregoing embodiments.

In a fifth aspect, the present application further provides a computer program product which includes a computer program. The computer program, when executed by a processor, implement steps of the video lag detection method of any of the foregoing embodiments.

With the above-mentioned video lag detection method, video lag detection device, computer device, computer-readable storage medium and computer program product, the lag parameter value corresponding to the to-be-detected video are obtained based on the video processing hardware; then the lag parameter value is processed based on the frame rate of the to-be-detected video to obtain the relative lag parameter value; and lag detection is performed on the to-be-detected video based on the relative lag parameter value. The lag parameter value is obtained from output of the hardware, which takes full advantage of hardware resources, and lag detection is automatedly performed on the to-be-detected video. In addition, it does not need to consume too many resources in time and computation, and no computation on inter-frame relationship is required. Video frames with slow process can be effectively detected, and lag detection precision and output are relatively high.

### BRIEF DESCRIPTION OF THE DRAWINGS

To better clarify the technical solutions in the embodiments of the present application or the related technology, the following will briefly introduce the drawings that need to be used in the description of the embodiments of the present application or the related technology. It is obvious that the drawings in the following description are only for some of the embodiments of the present application. Other related drawings can be obtained by the person of ordinary skill in the art according to these drawings without creative labors.

FIG. 1 is a schematic flowchart of a video lag detection method according to an embodiment;

FIG. 2 is a flowchart of obtaining a lag parameter according to an embodiment;

FIG. 3 is another schematic flowchart of a video lag detection method according to an embodiment;

FIG. 4 is a flowchart of a step of determining a lag reason according to an embodiment;

FIG. 5 is a structural block diagram of a video lag detection device according to an embodiment; and

FIG. 6 illustrates an internal structure of a computer device according to an embodiment.

### DETAILED DESCRIPTION

To further clarify and better understand intentions, technical solutions and advantages of the present application, the present application is further detailed hereinafter according to embodiments in conjunction with the drawings. It should be understood that the specific embodiments described herein are only for purpose of explaining the present application rather than limiting the present application.

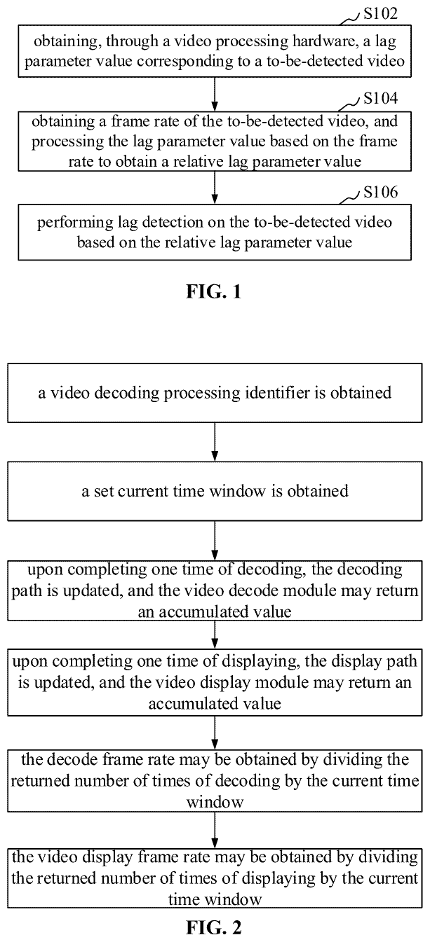

According to an embodiment, as shown in FIG. 1, a video lag detection method is provided. In the embodiment, it is exemplified by an example that the video lag detection method is applied to a terminal. It is understood that the video lag detection method may alternatively be applied to a server, or it may be applied to a system including a terminal and a server and realized by interactions between the terminal and the server. In the embodiment, the video lag detection method includes following steps S102 to S106.

S102 includes: obtaining, through a video processing hardware, a lag parameter value corresponding to a to-be-detected video.

The lag parameter value corresponds to the to-be-detected video. The lag parameter value may include at least one of a decode frame rate or a video display frame rate. For example, the lag parameter value includes the decode frame rate, or the lag parameter value includes the video display frame rate, or the lag parameter value includes the decode frame rate and the video display frame rate. The decode frame rate indicates decode frames per second (DFPS), and the video display frame rate indicates video display frames per second (VFPS). Here, the video display frame rate, different from a refresh frame rate of a display, is only related to a current number of times of displaying of video frames.

The lag parameter value is obtained through the video processing hardware. For example, the decode frame rate is obtained by a video decode module of a GPU, and the video display frame rate is obtained by a video display module. In completion of one time of decoding or one time of displaying, a relevant hardware module may return an accumulated state value for a system interface to access. This means, by calculating a decode state value and a display state value, the decode frame rate and the video display frame rate during video playing can be obtained in real time, providing favorable data support for video lag detection.

It is exemplified as follows for facilitation of understanding. The video decode module, upon completing one time of decoding, updates a decoding path and returns an accumulated value to inform an application that decoding of a current frame is completed; at the same time, a timestamp may be generated to obtain a current decoding moment, and a number of times of decoding is increased by one. In this way, within one time window, the decode frame rate may be obtained from the number of times of decoding and the time window. Similarly, the video display module, upon completing one time of displaying, updates a display path and returns an accumulated value to inform the application that displaying of a current frame is completed; at the same time, a timestamp may be generated to obtain a current displaying moment, and a number of times of displaying is increased by one. In this way, within one time window, the video display frame rate can be obtained from the number of times of displaying and the time window.

In response to playing the video by a player, an identifier of a current process or a current thread is first obtained, where a current decode frame rate and a current video display frame rate are associated with the identifier of the current process or the current thread. By default, the decode frame rate (i.e., DFPS) and the video display frame rate (i.e., VFPS) of the GPU are obtained once per second (i.e., the time window is of a length of 1 second). According to other embodiments, the time window may be set to other lengths, which is not specifically limited herein.

S104 includes: obtaining a frame rate of the to-be-detected video, and processing the lag parameter value based on the frame rate to obtain a relative lag parameter value.

Here, the relative lag parameter value takes the frame rate (FR) of the to-be-detected video as the basis for lag detection. A relative decode frame rate ratio is obtained through |1−(DFPS/FR)| and a relative video display frame rate ratio is obtained through |1−(VFPS/FR)|, where DFPS indicates the decode frame rate and VFPS indicates the video display frame rate. Two parameters, i.e., the relative decode frame rate ratio and the relative video display frame rate ratio are obtained. The more values of the two parameters are approximate to 0, the smoother the video playing is; conversely, the more laggy the video playing is.

S106 includes: performing lag detection on the to-be-detected video based on the relative lag parameter value.

The lag detection in the embodiment is carried out based on thresholds, with each lag parameter value corresponding to a first lag threshold, and whether the to-be-detected video is lagged or not is determined by determining a relationship between the relative lag parameter value and the first lag threshold.

In an optional embodiment, the first lag threshold is a dynamic threshold and is related to the frame rate of the to-be-detected video. Since the relative lag parameter value ranges within [0, 1], the relative lag parameter value is theoretically 0 as long as the video is not lagged. However, in order to exclude minor interference, once a certain threshold is exceeded, for example, in a case that the relative decode frame rate ratio is greater than (1-28/30) for a video having the frame rate of 30 fps, the video is considered lagged. The first lag thresholds are different for videos with different frame rates. For example, frame rates of 23.98 fps and 24 fps correspond to one lag threshold, frame rate of 25 fps corresponds to one lag threshold, frame rates of 29.97 fps and 30 fps correspond to one lag threshold, and frame rates of 59.94 fps and 60 fps correspond to one lag threshold.

In the above-mentioned video lag detection method, the lag parameter value corresponding to the to-be-detected video is obtained through the video processing hardware, the lag parameter value is processed based on the frame rate of the to-be-detected video to obtain the relative lag parameter value, and then the lag detection is performed on the to-be-detected video based on the relative lag parameter value. The lag parameter value is obtained from output of the hardware, which takes full advantage of hardware resources, and lag detection is automatedly performed on the to-be-detected video. In addition, it does not need to consume too many resources in time and computation, and no computation on inter-frame relationship is required. Video frames with slow process can be effectively detected, and lag detection precision and output are relatively high.

In an optional embodiment, obtaining, through the video processing hardware, the lag parameter value corresponding to the to-be-detected video includes: obtaining a video decoding processing identifier corresponding to each channel of to-be-detected video; obtaining a current time window corresponding to the video decoding processing identifier; obtaining a number of times of video processing corresponding to each video decoding processing identifier returned by the video processing hardware within the current time window; and obtaining the lag parameter value of each channel to-be-detected video based on the corresponding number of times of video processing and the corresponding current time window.

The video decoding processing identifier may be a thread identifier or a process identifier. The process identifier or the thread identifier of each video playing application is uniquely determined, and the decoding path and the display path are also uniquely determined during video playing. In this way, the decoding and displaying of each channel of video can be tracked through the uniquely determined identifier. If necessary, a video decoding mode and a video display mode of each channel of video can also be obtained. The video display frame rate, different from the refresh frame rate of the display, is only related to a current number of times of displaying of video frames, and the number of times of displaying is related to the video display mode. In absence of human intervention, one process identifier or one thread identifier is associated with one video decoding mode and one video display mode, so the decoding path and the display path of one channel of video are determined. The process identifier or the thread identifier is obtained from an operating system.

In practice, process identifiers are the basis for decoding of multiple channels of videos, with which lag parameter values of respective channels of videos can be determined without confusion. Once a program starts running, the process identifier exists in the operating system. By binding process identifiers to lag parameter values, the lag parameter values of different video applications can be distinguished. The decoding path and the display path are configured by the video application, and as soon as the video starts playing, the decoding path and the display path are determined, so basically there may not occur a situation where the video is on one channel and is then on another channel. Therefore, the identifier is also bound to the decoding path and the display path, which is convenient for solving the lag problem.

The number of times of video processing includes at least one of the number of times of decoding or the number of times of displaying, corresponding to the above-mentioned decode frame rate and video display frame rate, respectively.

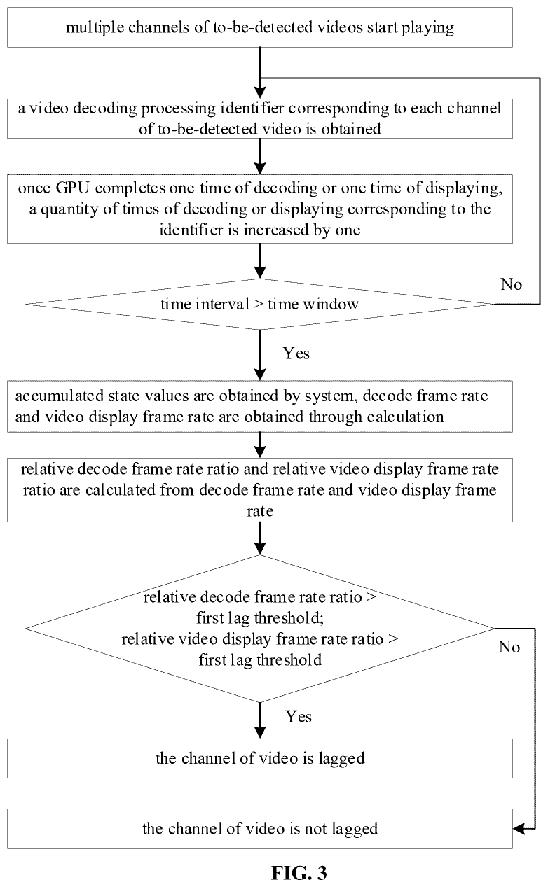

Reference may be made to FIG. 2, which illustrates processes of the step of obtaining the lag parameter according to an embodiment. When calculating the lag parameter, the video decoding processing identifier may be obtained first. Each channel of to-be-detected video corresponds to one identifier. If multiple identifiers are obtained, lag detection can be simultaneously carried out on multiple channels of to-be-detected videos, which further improves the efficiency of lag detection.

A set current time window is obtained. The current time window may be utilized to control the accuracy of lag detection. Lag detection parameters of videos themselves are different, and sizes of time windows are also different, which are obtained by a video decoding driver through parsing bitstream.

Upon completing one time of decoding, the decoding path is updated, and upon completing one time of displaying, the display path is updated. Upon completing one time of decoding, the video decode module may return an accumulated value to inform the application that decoding of a current frame is completed; at the same time, a timestamp may be generated to obtain a current decoding moment, and the number of times of decoding is increased by one. In this way, the decode frame rate may be obtained by dividing the returned number of times of decoding by the current time window.

Upon completing one time of displaying, the video display module may return an accumulated value to inform the application that displaying of a current frame is completed; at the same time, a timestamp may be generated to obtain a current displaying moment, and the number of times of displaying is increased by one. In this way, the video display frame rate may be obtained by dividing the returned number of times of displaying by the current time window.

In an optional embodiment, before obtaining the current time window corresponding to the video decoding processing identifier, the step of obtaining the lag parameter further includes: receiving a setting instruction for the current time window, the setting instruction carrying a detection sensitivity; and obtaining the current time window based on an inter-frame time interval of the to-be-detected video and the detection sensitivity.

The time window for the video display frame rate may be changed. The time window may be specified with any length of time and is generally set as an integer multiple of the inter-frame time interval. In this case, the relative video display frame rate ratio is |1−(VFPS′/FR′)|, where VFPS' and FR′ are the video display frame rate and a theoretical frame rate within the time window. The smaller the time window is, the higher the detection sensitivity is, so some video frames with slow process may be detected under small time window.

Theoretical inter-frame time interval information is contained in bitstream and may be obtained by the video decode module through analyzing the bitstream. In practice, different videos may have different inter-frame time intervals. Corresponding to the time window set in the specification, at the user, it is set a detection level which is related to the detection sensitivity, such as a low level, a medium level and a high level; and at the kernel, it is set a corresponding multiplier for the inter-frame time interval based on the detection level. For instance, the higher the detection sensitivity, the higher the detection level, the smaller the multiplier, and thus the smaller the time window.

In an optional embodiment, performing lag detection on the to-be-detected video based on the relative lag parameter value includes: updating a lag count if the relative lag parameter value is greater than the first lag threshold; obtaining a lag count threshold corresponding to the to-be-detected video, the lag count threshold being positively correlated with duration information of the to-be-detected video; and determining that playing of the to-be-detected video is lagged if the lag count is greater than the lag count threshold.

The lag count is obtained from statistical analysis on diagnostic states within multiple time windows. Throughout the playing of the video, lag exists and is not cleared. For each occurrence of lag, the lag count is increased, for example, by adding 1. In the embodiment, whether there occurs lags may be determined based on individual relative lag parameter values, and the lag count is increased for each occurrence of lag determined based on any individual relative lag parameter value. In other embodiments, the lag count is increased only for occurrence of lag that is determined based on each of the relative lag parameter values. For example, the lag count is increased only when occurrence of lag is determined based on both the relative decode frame rate ratio and the relative video display frame rate ratio.

The diagnostic state is collected once per time window, and is reset in a next time window and collected again. Lag detection during playing based on the lag count can take multiple time windows into full consideration.

The lag count threshold n is positively correlated with the duration information of the to-be-detected video. For local video tests and online video tests, n is a variable positively correlated with a video duration. For online live service tests, n is a variable related to a playing duration.

In the embodiment, the diagnostic states corresponding to respective lag parameters and the lag count in total can be obtained. In response to the lag count being greater than n, it is output that the playing is lagged.

In an optional embodiment, the video lag detection method further includes: obtaining the first lag threshold based on the frame rate of the to-be-detected video.

Since the relative lag parameter value ranges within [0, 1], the relative lag parameter value is theoretically 0 as long as the video is not lagged. However, in order to exclude minor interference, once a certain threshold is exceeded, for example, in a case that the relative decode frame rate ratio is greater than (1-28/30) for a video having the frame rate of 30 fps, the video is considered lagged. The first lag thresholds are different for videos with different frame rates. For example, frame rates of 23.98 fps and 24 fps correspond to one lag threshold, frame rate of 25 fps corresponds to one lag threshold, frame rates of 29.97 fps and 30 fps correspond to one lag threshold, and frame rates of 59.94 fps and 60 fps correspond to one lag threshold.

In an optional embodiment, the video lag detection method further includes: obtaining an auxiliary lag parameter value; and performing lag detection on the to-be-detected video based on the auxiliary lag parameter value.

The auxiliary lag parameter value is a Central Processing Unit (CPU) usage. The CPU usage is an auxiliary reference for video lag detection. In some scenarios, video lag is related to the CPU. For example, environments for video playing tests are varied, and in some cases, the CPU usage may be very high and exceed its confidence interval. In these cases, the communication between the GPU and the CPU may be interrupted and the video module or display module of the GPU may be caused to temporarily stop working, resulting in lag. Therefore, video lag may not be directly caused by the GPU, and it shall be first verified whether video lag is resulted from excessive CPU usage.

The CPU usage is obtained from the operating system.

In the embodiment, a relative auxiliary lag parameter value may also be obtained. For example, the auxiliary lag parameter value is directly utilized as the relative auxiliary lag parameter value; the more the auxiliary lag parameter value is approximate to 0, the smoother the video playing is, and conversely, the more laggy the video playing is.

In an optional embodiment, the video lag detection method further includes: outputting a diagnostic state corresponding to the relative lag parameter value in a case where the relative lag parameter value is greater than the first lag threshold; outputting a diagnostic state corresponding to the auxiliary lag parameter value in a case where the auxiliary lag parameter value is greater than a second lag threshold; and determining a lag reason based on the diagnostic state corresponding to the relative lag parameter value and the diagnostic state corresponding to the auxiliary lag parameter value.

The diagnostic state is collected once per time window and is reset in a next time window. Each parameter, including the lag parameter value and the auxiliary lag parameter value, has a corresponding diagnostic state. Each time the diagnostic state corresponding to any parameter indicates occurrence of lag, the lag count is increased.

In the embodiment, the lag count is 0 initially, and the diagnostic state corresponding to each parameter is 0 initially. In other embodiments, initial values for the lag count and the diagnostic states may be set to other values, and no specific limitation is made herein.

In a case that the relative decode frame rate ratio at a certain moment exceeds the first lag threshold, it is considered that a lag occurs at the moment. Accordingly, the lag count is increased by one, and a corresponding diagnostic state State_{DFPS} is written as 1. For a local test, lag moments relative to a total video duration are recorded; alternatively, for an online test, lag moments relative to a playing duration are recorded.

In a case that the relative decode frame rate ratio does not exceed the first lag threshold, but the relative video display frame rate ratio exceeds the corresponding first lag threshold, it is considered that a lag occurs at this time. Accordingly, the lag count is increased by one, and a corresponding diagnostic state State_{VFPS} is written as 1. Time information is recorded in a similar way as described hereinbefore. Here, the threshold for each of the relative decode frame rate and the relative video display frame rate is expressed as the first lag threshold only for convenience, and it is not intended to indicate that the thresholds for the relative decode frame rate and the relative video display frame rate are the same.

In a case that the CPU usage exceeds the second lag threshold, regardless of whether the relative decode frame rate ratio and relative video display frame rate ratio exceed their corresponding confidence intervals, a lag warning is issued and a corresponding diagnostic state State_{CPU} is written as 1. The warning indicates that there is a high probability that the video is lagged. Environments for video playing tests are varied, and in some cases, the CPU usage may be very high and exceed its confidence interval. In these cases, the communication between the GPU and the CPU may be interrupted and the video module or display module of the GPU may be caused to temporarily stop working, resulting in lag. Therefore, video lag may not be directly caused by the GPU, and it shall be first verified whether video lag is resulted from excessive CPU usage.

Subsequently, determining the lag reason based on the diagnostic state corresponding to the relative lag parameter value and the diagnostic state corresponding to the auxiliary lag parameter value includes: firstly determining a CPU usage state.

If State_{CPU}=1, State_{DFPS}=1 and State_{VFPS}=1, an application software playing lag warning is issued and it is determined from these states that a lag is caused by a software platform. In this case, if the relative decode frame rate ratio is equal to 1, it is further determined that video playing is not accelerated using GPU. If State_{CPU}=0, State_{DFPS}=1 and State_{VFPS}=1, it is determined that video lag is caused by the GPU. If State_{DFPS}=0 and State_{VFPS}=1, it is determined that video lag is not caused by the video decode module of the GPU. In this case, the lag may be resulted from system software factors, or may be caused by modules of the GPU other than the video decode module, which requires further analysis by professionals.

In an optional embodiment, the video lag detection method further includes: in a case where the relative lag parameter value is greater than the first lag threshold, recording a video moment corresponding to the relative lag parameter value, a decoding mode of the to-be-detected video, and a display mode of the to-be-detected video; and performing a lag analysis based on the video moment corresponding to the relative lag parameter value, the decoding mode of the to-be-detected video, and the display mode of the to-be-detected video.

When a lag occurs, the program first updates information such as the lag count, parameter states and time, and then analyzes the parameter states related to the lag, which in turn gives a lag analysis recommendation. The lag analysis recommendation indicates the reason for occurrence of the lag.

The analysis may be carried out by performing a reproduction of the to-be-detected video, and the reproduction may be achieved by a playback of the to-be-detected video based on the recorded parameters. Other concerned parameters can be obtained during the video playback, which facilitates the determination of the lag reason.

In the present embodiment, other information about the lag moment, such as information about time at which the lag occurs, the video decoding mode and the video display mode, is recorded. Consequently, it is easy to reproduce the lag problem. By reproducing the lag problem based on these recorded parameters, the time cost for the GPU manufacturers to find out lag reasons can be significantly reduced, facilitating the manufacturers in optimizing and improving the GPU devices.

Reference can be made to FIG. 3, which illustrates partial flowchart of a video lag detection method according to an embodiment. In the embodiment, the video lag detection mainly includes three steps: a first step is playing a video and obtaining parameters, a second step is detecting a lag, and a third step is determining a lag reason.

FIG. 3 shows a procedure of lag detection in the second step. The lag detection may be applied to detect lags in multiple channels of videos. Firstly, multiple channels (more than one channel) of to-be-detected videos start playing. Then, a video decoding processing identifier corresponding to each channel of to-be-detected video is obtained. In addition, once a GPU completes one time of decoding or one time of displaying, a number of times of decoding or displaying corresponding to the identifier is increased by one. If a time interval is greater than or equal to a current time window, an accumulated state value corresponding to the current time window is obtained. A decode frame rate is obtained based on the number of times of decoding, a video display frame rate is obtained based on the number of times of displaying, and a CPU usage is obtained. A relative decode frame rate ratio is obtained based on the decode frame rate, and a relative video display frame rate ratio is obtained based on the video display frame rate. In a case that the relative decode frame rate ratio is greater than its corresponding first lag threshold and the relative video display frame rate ratio is greater than its corresponding first lag threshold, it is indicated that the channel of video is lagged.

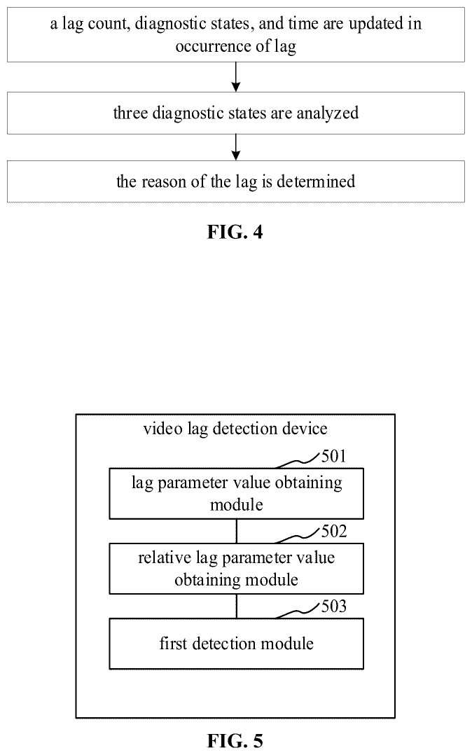

Reference can be made to FIG. 4, which is a flowchart of the step of determining the lag reason according to an embodiment. In the embodiment, in confirmation of occurrence of a lag, a lag count, diagnostic states corresponding to parameters, and time at which the lag occurs are updated. Then, the diagnostic states are analyzed, and the lag reason is determined.

In the foregoing embodiments, lag detection for a single channel of video or for multiple channels of videos can be accomplished by means of obtaining the decode frame rate and the video display frame rate of the GPU. The lag detection technique does not rely on specific OS platforms and system playing software. In addition, the parameters for lag detection can be obtained directly from the sending end, there are clear nodes in the whole process, and the output results are stable and able to be provided in visualized interfaces or reports; consequently, lag detection can be automatedly run on some scenarios instead of tests based on human eyes, and can be automatedly performed on multiple channels of videos. Furthermore, it does not need to consume too many resources in time and computation, and no computation on inter-frame relationship is required. Video frames with slow process can be effectively detected, and lag detection precision and output are relatively high. In occurrence of video lags, reasons of the lags can be located and analysis suggestions can be given, facilitating the manufacturers in optimizing and improving relevant products. Moreover, the parameters recorded in the detection process are easy to adjust and expand, leading to high flexibility of lag detection.

It should be understood that although the individual steps in the flowcharts involved in the embodiments as described above are shown sequentially as indicated by arrows, these steps are not necessarily executed sequentially in the order indicated by the arrows. Unless expressly stated herein, there is no strict order limitation on the execution of these steps, and these steps may be executed in other orders. Moreover, at least a portion of the steps in the flowcharts involved in the embodiments as described above may include multiple sub-steps or multiple phases. The sub-steps or phases are not necessarily executed and completed simultaneously, but may be executed at different moments. These sub-steps or phases are not necessarily sequentially executed, but may be executed in conjunction with at least a portion of other steps or a portion of sub-steps or phases of other steps in turn or alternately.

Based on the same inventive concept, a video lag detection device is further provided according to an embodiment of the present application, which can implement the above-mentioned video lag detection method. Solutions for solving technical problem provided by the device are similar to those recited in the above-mentioned method, so specific limitations in one or more embodiments directed to the video lag detection device provided below can be understood with reference to limitations described for the video lag detection method, which are not repeated herein.

A video lag detection device is provided according to an exemplary embodiment. As shown in FIG. 5, the video lag detection device includes: a lag parameter value obtaining module 501, a relative lag parameter value obtaining module 502, and a first detection module 503.

The lag parameter value obtaining module 501 is configured to obtain, through a video processing hardware, a lag parameter value corresponding to a to-be-detected video.

The relative lag parameter value obtaining module 502 is configured to obtain a frame rate of the to-be-detected video, and process the lag parameter value based on the frame rate to obtain a relative lag parameter value.

The first detection module 503 is configured to perform lag detection on the to-be-detected video based on the relative lag parameter value.

According to an optional embodiment, the lag parameter value includes at least one of a decode frame rate or a video display frame rate.

According to an optional embodiment, the lag parameter value obtaining module 501 is specifically configured to: obtain a video decoding processing identifier corresponding to each channel of to-be-detected video; obtain a current time window corresponding to the video decoding processing identifier; obtain a number of times of video processing corresponding to each video decoding processing identifier returned by the video processing hardware within the current time window; and obtain the lag parameter value of each channel to-be-detected video based on the corresponding number of times of video processing and the corresponding current time window.

According to an optional embodiment, the video lag detection device further includes a time window setting module. The time window setting module is configured to: receive a setting instruction for the current time window, the setting instruction carrying a detection sensitivity; and obtain the current time window based on an inter-frame time interval of the to-be-detected video and the detection sensitivity.

According to an optional embodiment, the first detection module 503 is specifically configured to: update a lag count if the relative lag parameter value is greater than a first lag threshold; obtain a lag count threshold corresponding to the to-be-detected video, the lag count threshold being positively correlated with duration information of the to-be-detected video; and determine that playing of the to-be-detected video is lagged if the lag count is greater than the lag count threshold.

According to an optional embodiment, the first detection module 503 is further configured to obtain the first lag threshold based on the frame rate of the to-be-detected video.

According to an optional embodiment, the video lag detection device further includes an auxiliary lag parameter obtaining module, which is configured to: obtain an auxiliary lag parameter value, and perform lag detection on the to-be-detected video based on the auxiliary lag parameter value.

According to an optional embodiment, the video lag detection device further includes a diagnosis module, which is configured to: output a diagnostic state corresponding to the relative lag parameter value in a case where the relative lag parameter value is greater than the first lag threshold; output a diagnostic state corresponding to the auxiliary lag parameter value in a case where the auxiliary lag parameter value is greater than a second lag threshold; and determine a lag reason based on the diagnostic state corresponding to the relative lag parameter value and the diagnostic state corresponding to the auxiliary lag parameter value.

According to an optional embodiment, the video lag detection device further includes an analysis module, which is configured to: record a video moment corresponding to the relative lag parameter value, a decoding mode of the to-be-detected video, and a display mode of the to-be-detected video in a case where the relative lag parameter value is greater than the first lag threshold; and perform a lag analysis based on the video moment corresponding to the relative lag parameter value, the decoding mode of the to-be-detected video, and the display mode of the to-be-detected video.

Each module in the above-mentioned video lag detection device may be embodied, in whole or in part, by software, hardware or a combination thereof. Each module may be embedded in or independent of a processor of a computer device in hardware form or may be stored in a memory of the computer device in software form, so that each module can be invoked by the processor to perform an operation corresponding to the each module.

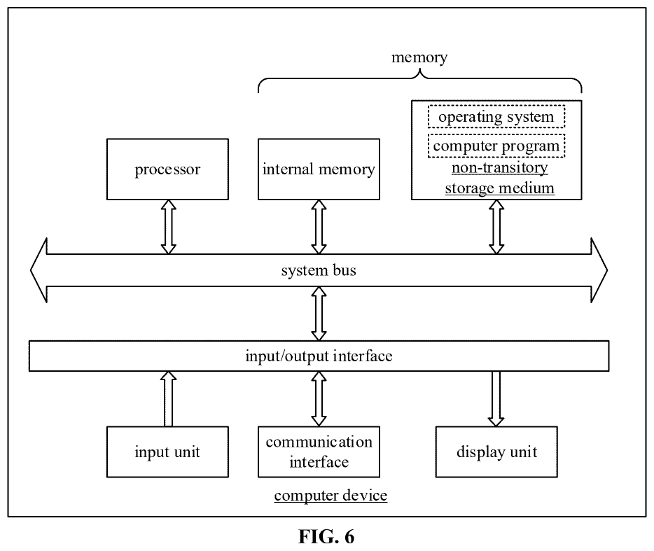

A computer device is provided according to an exemplary embodiment. The computer device may be a terminal. An internal structure of the computer device may be shown in FIG. 6. The computer device includes a processor, a memory, an input/output interface, a communication interface, a display unit, and an input unit. The processor, the memory and the input/output interface are connected via a system bus. The communication interface, the display unit and the input unit are connected to the system bus via the input/output interface. The processor of the computer device offers computing and controlling functionality. The memory of the computer device includes a non-transitory storage medium and an internal memory. The non-transitory storage medium stores an operating system and a computer program. The internal memory provides an environment for the operation of the operating system and the computer program stored in the non-transitory storage medium. The input/output interface of the computer device is responsible for information exchange between the processor and an external device. The communication interface of the computer device is configured to communicate with an external terminal in a wired or wireless manner. Here, the wireless manner may be realized through WIFI, mobile cellular network, Near Field Communication (NFC) or other technologies. The computer program, when executed by a processor, implements a video lag detection method. The display unit of the computer device is responsible for generating a visible image, which may be a display, a projection device, or a virtual reality imaging device. The display may be an LCD or an e-ink display. The input unit of the computer device may be a touch layer covered on the display, a button, a trackball or a touchpad provided on a housing of the computer device, or a keyboard, a touchpad or a mouse external to the computer device.

It is understandable by those skilled in the art that FIG. 6 is a block diagram merely illustrating a partial structure related to the technical solution of the present application, and the computer device provided in the technical solution of the present application is not limited by FIG. 6. Specifically, the computer device may include more or fewer components than as shown in FIG. 6, or some of the components in FIG. 6 can be integrated, or the components may be deployed in a way different from that shown in FIG. 6.

A computer device is provided according to an exemplary embodiment. The computer device includes a memory and a processor. A computer program is stored in the memory. The processor implements the following steps when executing the computer program: obtaining a lag parameter value corresponding to a to-be-detected video through a video processing hardware; obtaining a frame rate of the to-be-detected video, and processing the lag parameter value based on the frame rate to obtain a relative lag parameter value; and performing lag detection on the to-be-detected video based on the relative lag parameter value.

According to an embodiment, the lag parameter value involved in the execution of the computer program by the processor includes at least one of a decode frame rate or a video display frame rate.

According to an embodiment, obtaining the lag parameter value corresponding to the to-be-detected video through the video processing hardware implemented by the processor when executing the computer program includes: obtaining a video decoding processing identifier corresponding to each channel of to-be-detected video; obtaining a current time window corresponding to the video decoding processing identifier; obtaining a number of times of video processing corresponding to each video decoding processing identifier returned by the video processing hardware within the current time window; and obtaining the lag parameter value of each channel to-be-detected video based on the corresponding number of times of video processing and the corresponding current time window.

According to an embodiment, before obtaining the current time window corresponding to the video decoding processing identifier, the processor, when executing the computer program, further implements: receiving a setting instruction for the current time window, the setting instruction carrying a detection sensitivity; and obtaining the current time window based on an inter-frame time interval of the to-be-detected video and the detection sensitivity.

According to an embodiment, performing lag detection on the to-be-detected video based on the relative lag parameter value implemented by the processor when executing the computer program includes: updating a lag count if the relative lag parameter value is greater than a first lag threshold; obtaining a lag count threshold corresponding to the to-be-detected video, the lag count threshold being positively correlated with duration information of the to-be-detected video; and determining that playing of the to-be-detected video is lagged if the lag count is greater than the lag count threshold.

According to an embodiment, the processor, when executing the computer program, further implements: obtaining the first lag threshold based on the frame rate of the to-be-detected video.

According to an embodiment, the processor, when executing the computer program, further implements: obtaining an auxiliary lag parameter value, and performing lag detection on the to-be-detected video based on the auxiliary lag parameter value.

According to an embodiment, the processor, when executing the computer program, further implements: outputting a diagnostic state corresponding to the relative lag parameter value in a case where the relative lag parameter value is greater than the first lag threshold; outputting a diagnostic state corresponding to the auxiliary lag parameter value in a case where the auxiliary lag parameter value is greater than a second lag threshold; and determining a lag reason based on the diagnostic state corresponding to the relative lag parameter value and the diagnostic state corresponding to the auxiliary lag parameter value.

According to an embodiment, the processor, when executing the computer program, further implements: recording a video moment corresponding to the relative lag parameter value, a decoding mode of the to-be-detected video, and a display mode of the to-be-detected video in a case where the relative lag parameter value is greater than the first lag threshold; and performing a lag analysis based on the video moment corresponding to the relative lag parameter value, the decoding mode of the to-be-detected video, and the display mode of the to-be-detected video.

A computer-readable storage medium is provided according to an embodiment. The storage medium stores thereon a computer program. The computer program, when executed by a processor, implements the following steps: obtaining a lag parameter value corresponding to a to-be-detected video through a video processing hardware; obtaining a frame rate of the to-be-detected video, and processing the lag parameter value based on the frame rate to obtain a relative lag parameter value; and performing lag detection on the to-be-detected video based on the relative lag parameter value.

According to an embodiment, the lag parameter value involved in the execution of the computer program by the processor includes at least one of a decode frame rate or a video display frame rate.

According to an embodiment, obtaining the lag parameter value corresponding to the to-be-detected video through the video processing hardware implemented when the computer program is executed by the processor includes: obtaining a video decoding processing identifier corresponding to each channel of to-be-detected video; obtaining a current time window corresponding to the video decoding processing identifier; obtaining a number of times of video processing corresponding to each video decoding processing identifier returned by the video processing hardware within the current time window; and obtaining the lag parameter value of each channel to-be-detected video based on the corresponding number of times of video processing and the corresponding current time window.

According to an embodiment, before obtaining the current time window corresponding to the video decoding processing identifier, the computer program, when executed by the processor, further implements: receiving a setting instruction for the current time window, the setting instruction carrying a detection sensitivity; and obtaining the current time window based on an inter-frame time interval of the to-be-detected video and the detection sensitivity.

According to an embodiment, performing lag detection on the to-be-detected video based on the relative lag parameter value implemented when the computer program is executed by the processor includes: updating a lag count if the relative lag parameter value is greater than a first lag threshold; obtaining a lag count threshold corresponding to the to-be-detected video, the lag count threshold being positively correlated with duration information of the to-be-detected video; and determining that playing of the to-be-detected video is lagged if the lag count is greater than the lag count threshold.

According to an embodiment, the computer program, when executed by the processor, further implements: obtaining the first lag threshold based on the frame rate of the to-be-detected video.

According to an embodiment, the computer program, when executed by the processor, further implements: obtaining an auxiliary lag parameter value, and performing lag detection on the to-be-detected video based on the auxiliary lag parameter value.

According to an embodiment, the computer program, when executed by the processor, further implements: outputting a diagnostic state corresponding to the relative lag parameter value in a case where the relative lag parameter value is greater than the first lag threshold; outputting a diagnostic state corresponding to the auxiliary lag parameter value in a case where the auxiliary lag parameter value is greater than a second lag threshold; and determining a lag reason based on the diagnostic state corresponding to the relative lag parameter value and the diagnostic state corresponding to the auxiliary lag parameter value.

According to an embodiment, the computer program, when executed by the processor, further implements: recording a video moment corresponding to the relative lag parameter value, a decoding mode of the to-be-detected video, and a display mode of the to-be-detected video in a case where the relative lag parameter value is greater than the first lag threshold; and performing a lag analysis based on the video moment corresponding to the relative lag parameter value, the decoding mode of the to-be-detected video, and the display mode of the to-be-detected video.

A computer program product is provided according to an embodiment, including a computer program. The computer program, when executed by a processor, implements the following steps: obtaining a lag parameter value corresponding to a to-be-detected video through a video processing hardware; obtaining a frame rate of the to-be-detected video, and processing the lag parameter value based on the frame rate to obtain a relative lag parameter value; and performing lag detection on the to-be-detected video based on the relative lag parameter value.

According to an embodiment, the lag parameter value involved in the execution of the computer program by the processor includes at least one of a decode frame rate or a video display frame rate.

According to an embodiment, obtaining the lag parameter value corresponding to the to-be-detected video through the video processing hardware implemented when the computer program is executed by the processor includes: obtaining a video decoding processing identifier corresponding to each channel of to-be-detected video; obtaining a current time window corresponding to the video decoding processing identifier; obtaining a number of times of video processing corresponding to each video decoding processing identifier returned by the video processing hardware within the current time window; and obtaining the lag parameter value of each channel to-be-detected video based on the corresponding number of times of video processing and the corresponding current time window.

According to an embodiment, before obtaining the current time window corresponding to the video decoding processing identifier, the computer program, when executed by the processor, further implements: receiving a setting instruction for the current time window, the setting instruction carrying a detection sensitivity; and obtaining the current time window based on an inter-frame time interval of the to-be-detected video and the detection sensitivity.

According to an embodiment, performing lag detection on the to-be-detected video based on the relative lag parameter value implemented when the computer program is executed by the processor includes: updating a lag count if the relative lag parameter value is greater than a first lag threshold; obtaining a lag count threshold corresponding to the to-be-detected video, the lag count threshold being positively correlated with duration information of the to-be-detected video; and determining that playing of the to-be-detected video is lagged if the lag count is greater than the lag count threshold.

According to an embodiment, the computer program, when executed by the processor, further implements: obtaining the first lag threshold based on the frame rate of the to-be-detected video.

According to an embodiment, the computer program, when executed by the processor, further implements: obtaining an auxiliary lag parameter value, and performing lag detection on the to-be-detected video based on the auxiliary lag parameter value.

According to an embodiment, the computer program, when executed by the processor, further implements: outputting a diagnostic state corresponding to the relative lag parameter value in a case where the relative lag parameter value is greater than the first lag threshold; outputting a diagnostic state corresponding to the auxiliary lag parameter value in a case where the auxiliary lag parameter value is greater than a second lag threshold; and determining a lag reason based on the diagnostic state corresponding to the relative lag parameter value and the diagnostic state corresponding to the auxiliary lag parameter value.

According to an embodiment, the computer program, when executed by the processor, further implements: recording a video moment corresponding to the relative lag parameter value, a decoding mode of the to-be-detected video, and a display mode of the to-be-detected video in a case where the relative lag parameter value is greater than the first lag threshold; and performing a lag analysis based on the video moment corresponding to the relative lag parameter value, the decoding mode of the to-be-detected video, and the display mode of the to-be-detected video.

A person of ordinary skill in the art may understand that all or part of the processes in the methods of the foregoing embodiments can be accomplished by a computer program instructing a relevant hardware. The computer program may be stored in a non-transitory computer-readable storage medium. The computer program, when being executed, may include processes of methods according to various embodiments described above. Any memory, database, or other medium referred to in the embodiments provided in the application may include at least one of a non-transitory memory and a transitory memory. The non-transitory memory may include Read-Only Memory (ROM), magnetic tape, floppy disk, flash memory, optical memory, high-density embedded non-transitory memory, Resistive Random Access Memory (ReRAM), Magnetoresistive Random Access Memory (ReRAM), Ferroelectric Random Access Memory (FRAM), Phase Change Memory (PCM), Graphene Memory and so on. The transitory memory may include a Random Access Memory (RAM), an external cache, or the like. For illustration rather than limitation, the RAM may be in various forms, such as Static Random Access Memory (SRAM), Dynamic Random Access Memory (DRAM), or the like. The database involved in any embodiment provided in the present application may include at least one of a relational database and a non-relational database. The non-relational database may include and is not limited to a blockchain-based distributed database. The processor involved in any embodiment provided in the present application may be a general-purpose processor, a central processing unit, a graphics processing unit, a digital signal processor, a programmable logic, a data processing logic based on quantum computing, an artificial intelligence (AI) processor, and the like, which is not limited herein.

The various technical features of the above embodiments may be combined arbitrarily. Possible combinations of the various technical features of the above embodiments are not enumerated for brevity of description. However, as long as there is no contradiction in the combinations of these technical features, they should be considered to be within the scope of protection of the present disclosure.

The above-described embodiments only give several implementations of the present application. Although these embodiments are described in a specific and detailed manner, they shall not be construed as limitations to the scope of protection of the present application. It should be pointed out that for a person of ordinary skill in the art, various deformations and improvements can be made without departing from the conception of the present application, which all fall within the scope of protection of the present application. Therefore, the scope of protection of the application shall be subject to the attached claims.

What is claimed is:

1. A video lag detection method, comprising:
obtaining, through a video processing hardware, a lag parameter value corresponding to a to-be-detected video;
obtaining a frame rate of the to-be-detected video, and processing the lag parameter value based on the frame rate to obtain a relative lag parameter value; and
performing lag detection on the to-be-detected video based on the relative lag parameter value.

2. The video lag detection method according to claim 1, wherein the lag parameter value comprises at least one of a decode frame rate or a video display frame rate.

3. The video lag detection method according to claim 1, wherein obtaining, based on the video processing hardware, the lag parameter value corresponding to the to-be-detected video comprises:
obtaining a video decoding processing identifier corresponding to each channel of the to-be-detected video;
obtaining a current time window corresponding to the video decoding processing identifier;
obtaining a number of times of video processing corresponding to each video decoding processing identifier returned by the video processing hardware within the current time window; and
obtaining the lag parameter value of each channel the to-be-detected video based on the corresponding number of times of video processing and the corresponding current time window.

4. The video lag detection method according to claim 3, before obtaining the current time window corresponding to the video decoding processing identifier, further comprising:
receiving a setting instruction for the current time window, the setting instruction carrying a detection sensitivity; and
obtaining the current time window based on an inter-frame time interval of the to-be-detected video and the detection sensitivity.

5. The video lag detection method according to claim 1, wherein performing lag detection on the to-be-detected video based on the relative lag parameter value comprises:
updating a lag count in a case where the relative lag parameter value is greater than a first lag threshold;
obtaining a lag count threshold corresponding to the to-be-detected video, the lag count threshold being positively correlated with a duration of the to-be-detected video; and
determining that playing of the to-be-detected video is lagged in a case where the lag count is greater than the lag count threshold.

6. The video lag detection method according to claim 5, further comprising:
obtaining the first lag threshold based on the frame rate of the to-be-detected video.

7. The video lag detection method according to claim 1, further comprising:
obtaining an auxiliary lag parameter value; and
performing lag detection on the to-be-detected video based on the auxiliary lag parameter value.

8. The video lag detection method according to claim 7, further comprising:
outputting a diagnostic state corresponding to the relative lag parameter value in a case where the relative lag parameter value is greater than a first lag threshold;
outputting a diagnostic state corresponding to the auxiliary lag parameter value in a case where the auxiliary lag parameter value is greater than a second lag threshold; and
determining a lag reason based on the diagnostic state corresponding to the relative lag parameter value and the diagnostic state corresponding to the auxiliary lag parameter value.

9. The video lag detection method according to claim 7, further comprising:
recording a video moment corresponding to the relative lag parameter value, a decoding mode of the to-be-detected video, and a display mode of the to-be-detected video in a case where the relative lag parameter value is greater than a first lag threshold; and
performing a lag analysis based on the video moment corresponding to the relative lag parameter value, the decoding mode of the to-be-detected video, and the display mode of the to-be-detected video.

10. A video lag detection device, comprising a non-transitory memory and a processor, wherein a computer program is stored in the memory, and the processor, when executing the computer program, performs:
obtaining, based on a video processing hardware, a lag parameter value corresponding to a to-be-detected video;
obtaining a frame rate of the to-be-detected video, and processing the lag parameter value based on the frame rate to obtain a relative lag parameter value; and
performing lag detection on the to-be-detected video based on the relative lag parameter value.

11. The video lag detection device according to claim 10, wherein the lag parameter value comprises at least one of a decode frame rate or a video display frame rate.

12. The video lag detection device according to claim 10, wherein obtaining, based on the video processing hardware, the lag parameter value corresponding to the to-be-detected video comprises:
obtaining a video decoding processing identifier corresponding to each channel of the to-be-detected video;
obtaining a current time window corresponding to the video decoding processing identifier;
obtaining a number of times of video processing corresponding to each video decoding processing identifier returned by the video processing hardware within the current time window; and
obtaining the lag parameter value of each channel the to-be-detected video based on the corresponding number of times of video processing and the corresponding current time window.

13. The video lag detection device according to claim 12, wherein before obtaining the current time window corresponding to the video decoding processing identifier, the processor, when executing the computer program, further implements:
receiving a setting instruction for the current time window, the setting instruction carrying a detection sensitivity; and
obtaining the current time window based on an inter-frame time interval of the to-be-detected video and the detection sensitivity.

14. The video lag detection device according to claim 10, wherein performing lag detection on the to-be-detected video based on the relative lag parameter value comprises:
updating a lag count in a case where the relative lag parameter value is greater than a first lag threshold;
obtaining a lag count threshold corresponding to the to-be-detected video, the lag count threshold being positively correlated with duration information of the to-be-detected video; and
determining that playing of the to-be-detected video is lagged in a case where the lag count is greater than the lag count threshold.

15. The video lag detection device according to claim 14, wherein the processor, when executing the computer program, further implements:
obtaining the first lag threshold based on the frame rate of the to-be-detected video.

16. The video lag detection device according to claim 10, wherein the processor, when executing the computer program, further implements:
obtaining an auxiliary lag parameter value; and
performing lag detection on the to-be-detected video based on the auxiliary lag parameter value.

17. The video lag detection device according to claim 16, wherein the processor, when executing the computer program, further implements:
outputting a diagnostic state corresponding to the relative lag parameter value in a case where the relative lag parameter value is greater than a first lag threshold;
outputting a diagnostic state corresponding to the auxiliary lag parameter value in a case where the auxiliary lag parameter value is greater than a second lag threshold; and
determining a lag reason based on the diagnostic state corresponding to the relative lag parameter value and the diagnostic state corresponding to the auxiliary lag parameter value.

18. The video lag detection device according to claim 16, wherein the processor, when executing the computer program, further implements:
recording a video moment corresponding to the relative lag parameter value, a decoding mode of the to-be-detected video, and a display mode of the to-be-detected video in a case where the relative lag parameter value is greater than a first lag threshold; and
performing a lag analysis based on the video moment corresponding to the relative lag parameter value, the decoding mode of the to-be-detected video, and the display mode of the to-be-detected video.

19. A computer-readable non-transitory storage medium, storing a computer program thereon, wherein the computer program, when executed by a processor, causes the processor to perform a video lag detection method, wherein the video lag detection method comprises:
obtaining, based on a video processing hardware, a lag parameter value corresponding to a to-be-detected video;
obtaining a frame rate of the to-be-detected video, and processing the lag parameter value based on the frame rate to obtain a relative lag parameter value; and
performing lag detection on the to-be-detected video based on the relative lag parameter value.

20. A computer program product, comprising a computer program, wherein the computer program, when executed by a processor, cause the processor to perform the video lag detection method according to claim 1.
